(19) United States
(12) Patent Application Publication
(10) Pub. No.: US 2015/0118549 A1
(43) Pub. Date: Apr. 30, 2015

(54) LITHIUM BATTERY

(71) Applicant: TOYOTA JIDOSHA KABUSHIKI KAISHA, Toyota-shi (JP)

(72) Inventor: Jun YOSHIDA, Suntou-gun (JP)

(21) Appl. No.: 14/525,512

(22) Filed: Oct. 28, 2014

(30) Foreign Application Priority Data
Oct. 29, 2013 (JP) 2013-224199

(51) Int. Cl. H01M 4/58; H01M 4/485; H01M 10/0568; H01M 10/052

(52) U.S. Cl. CPC H01M 4/5825; H01M 10/052; H01M 4/485; H01M 10/0568; H01M 2300/0025
USPC 429/199; 429/188

(57) ABSTRACT

The present invention is to provide a lithium battery with a higher initial capacity than ever before. Disclosed is a lithium battery containing: a cathode containing LiMPO₄ (in which M is at least one element selected from the group consisting of Co, Fe, Mn and Ni); an anode containing a lithium titanate; and a liquid electrolyte disposed between the cathode and the anode, wherein the liquid electrolyte contains a lithium salt and sodium salt, and wherein the content of the sodium salt is more than 0 mol % and less than 30 mol % when the total content of the lithium salt and the sodium salt is taken as 100 mol %.

### TECHNICAL FIELD

The present invention relates to a lithium battery with a higher initial capacity than ever before.

### BACKGROUND ART

Much research has been done on lithium batteries using LiCoPO₄ as the cathode active material. For example, disclosed in Patent Literature 1 is an invention relating to a lithium electrochemical battery using Li₄Ti₅O₁₂ as the anode active material, in which LiCoPO₄ is given as an example of the cathode active material, and a solution of a lithium salt, such as LiPF₆, is given as an example of the liquid electrolyte.

### CITATION LIST

Patent Literature 1: Japanese Patent Application Laid-Open No. 2012-033503

### SUMMARY OF INVENTION

### Technical Problem

As a result of a study done by the inventor of the present invention, it has found that LiCoPO₄ is a compound with a relatively high potential, while it shows low initial properties in the battery constitution disclosed in Patent Literature 1.

The present invention was achieved in light of the above circumstances of LiCoPO₄. An object of the present invention is to provide a lithium battery with a higher initial capacity than ever before.

### Solution to Problem

The lithium battery of the present invention is a lithium battery containing: a cathode containing LiMPO₄ (in which M is at least one element selected from the group consisting of Co, Fe, Mn and Ni); an anode containing a lithium titanate; and a liquid electrolyte disposed between the cathode and the anode, wherein the liquid electrolyte contains a lithium salt and sodium salt, and wherein the content of the sodium salt is more than 0 mol % and less than 30 mol % when the total content of the lithium salt and the sodium salt is taken as 100 mol %.

In the present invention, the lithium salt is preferably at least one lithium salt selected from the group consisting of LiPF₆, LiBF₄, LiClO₄, LiAsF₆, LiCF₃SO₃, LiN(SO₂CF₃)₂, LiN(SO₂C₂F₅)₂ and LiC(SO₂CF₃)₃.

In the present invention, the sodium salt is preferably at least one sodium salt selected from the group consisting of NaPF₆, NaBF₄, NaClO₄, NaAsF₆, NaCF₃SO₃, NaN(SO₂CF₃)₂, NaN(SO₂C₂F₅)₂ and NaC(SO₂CF₃)₃.

### Advantageous Effects of Invention

According to the present invention, by adding a specific amount of a sodium salt in combination with a lithium salt to a liquid electrolyte, lithium ions in the liquid electrolyte can be put into a state in which the ions are likely to desolvate; therefore, the initial capacity of the thus-obtained lithium battery can be higher than conventional lithium batteries.

### BRIEF DESCRIPTION OF DRAWINGS

FIG. 1 is a view of an example of the layer constitution of the lithium battery according to the present invention, and it is also a schematic sectional view of the layer constitution along the layer stacking direction.

FIG. 2 is a graph of the initial capacity (specific capacity) of the lithium batteries of Examples 1 and 2 and Comparative Examples 1 to 8, with respect to the content of NaPF₆ in the liquid electrolyte.

### DESCRIPTION OF EMBODIMENTS

The lithium battery of the present invention is a lithium battery containing: a cathode containing LiMPO₄ (in which M is at least one element selected from the group consisting of Co, Fe, Mn and Ni); an anode containing a lithium titanate; and a liquid electrolyte disposed between the cathode and the anode, wherein the liquid electrolyte contains a lithium salt and sodium salt, and wherein the content of the sodium salt is more than 0 mol % and less than 30 mol % when the total content of the lithium salt and the sodium salt is taken as 100 mol %.

As described above, LiCoPO₄ is a cathode active material with a relatively high potential. Therefore, LiCoPO₄ has such a problem that lithium ion insertion and extraction reactions are less likely to proceed and, as a result, LiCoPO₄ has low initial capacity. This is mainly because: lithium ion diffusion is slow in the cathode active material; lithium ion insertion and extraction reactions are inhibited by the decomposition of the liquid electrolyte; and it is difficult to bring lithium ions out of a solvated state.

In view of the above findings, the inventor of the present invention made many research to improve the initial properties of lithium batteries using LiMPO₄ (M=Co, Fe, Mn, Ni) as the cathode active material. As a result of diligent efforts, he has found that by using a liquid electrolyte in which a lithium salt and a sodium salt are contained at a specific mixing ratio, the lithium ion desolvation state in the liquid electrolyte can be better than conventional liquid electrolytes, and the initial capacity of a lithium battery can be increased by fast sodium ion diffusion. Based on this finding, he completed the present invention.

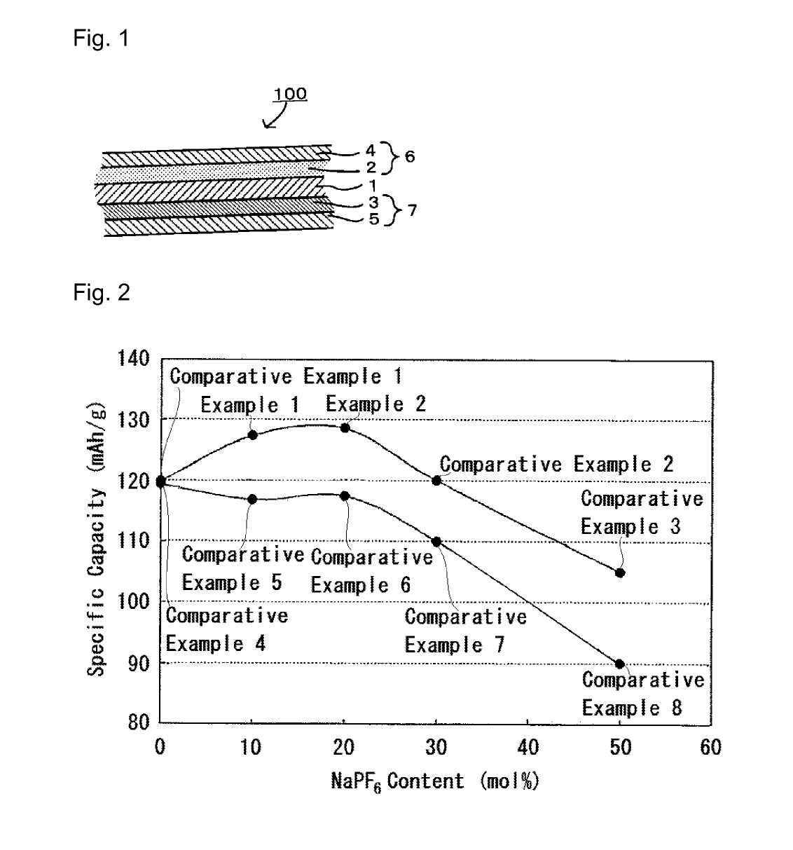

FIG. 1 is a view of an example of the layer constitution of the lithium battery according to the present invention, and it is also a schematic sectional view of the layer constitution along the layer stacking direction. The lithium battery of the present invention is not limited to this example.

A lithium battery 100 contains: a cathode 6 containing a cathode active material layer 2 and a cathode current collector 4; an anode 7 containing an anode active material layer 3 and an anode current collector 5; and an electrolyte layer 1 being present between the cathode 6 and the anode 7.

Hereinafter, those used in the lithium battery of the present invention, which are the cathode, the anode and the electrolyte layer, and those which are suitably used in the lithium battery of the present invention, which are a separator and a battery case, will be described in detail.

The cathode used in the present invention preferably contains a cathode active material layer containing LiMPO₄. In addition, it generally contains a cathode current collector and a cathode lead connected to the cathode current collector.

LiMPO₄ (in which M is at least one element selected from the group consisting of Co, Fe, Mn and Ni) used in the present invention is a cathode active material with a relatively high potential versus lithium. Therefore, by solving the above problem with initial capacity, a lithium battery which is able to produce higher voltage than ever before and which is more practical can be produced.

As described above, the element M in LiMPO₄ means at least one of the following elements: Co, Fe, Mn and Ni. That is, as the element M, LiMPO₄ contains at least one of the following elements: Co, Fe, Mn and Ni. In the present invention, therefore, only one of these four elements can be contained in LiMPO₄, or two or more of the elements can be contained in combination.

From the point of view that charging and discharging can be carried out at a relatively high potential (4.7 V vs. Li⁺/Li), it is preferable to use LiCoPO₄ as the LiMPO₄.

To synthesize LiMPO₄ (in which M is at least one element selected from the group consisting of Co, Fe, Mn and Ni), a sol-gel method can be used.

A typical example of the sol-gel method is as follows.

First, a lithium compound, a compound containing the element M (which is at least one element selected from the group consisting of Co, Fe, Mn and Ni) and a phosphate compound are prepared as raw materials. It is not needed to prepare all of the three kinds of compounds as raw materials. For example, when the lithium compound contains the element M, it is not needed to prepare another compound containing the element M.

As the lithium compound, there may be mentioned lithium carbonate (Li₂CO₃), lithium acetate (CH₃CO₂Li), lithium nitrate (LiNO₃) and hydrates thereof, for example.

When the element M is Co, as the cobalt compound, there may be mentioned cobalt(II) hydroxide (Co(OH)₂), cobalt(II) acetate (Co(CH₃CO₂)₂), cobalt(II) nitrate (Co(NO₃)₂), cobalt(II) sulfate (CoSO₄), cobalt(II) oxalate (CoC₂O₄), cobalt(II) chloride (CoCl₂) and hydrates thereof, for example.

When the element M is Fe, as the iron compound, there may be mentioned iron(II) hydroxide (Fe(OH)₂), iron(II) acetate (Fe(CH₃CO₂)₂), iron(II) nitrate (Fe(NO₃)₂), iron(II) sulfate (FeSO₄), iron(II) oxalate (FeC₂O₄), iron(III) chloride (FeCl₃) and hydrates thereof, for example.

When the element M is Mn, as the manganese compound, there may be mentioned manganese(II) oxide (MnO), manganese(II) acetate (Mn (CH₃CO₂)₂), manganese(II) nitrate (Mn(NO₃)₂), manganese(II) sulfate (MnSO₄), manganese(II) oxalate (MnC₂O₄), manganese(II) chloride (MnCl₂) and hydrates thereof, for example.

When the element M is Ni, as the nickel compound, there may be mentioned nickel(II) hydroxide (Ni(OH)₂), nickel(II) acetate (Ni(CH₃CO₂)₂), nickel(II) nitrate (Ni(NO₃)₂), nickel(II) sulfate (NiSO₄), nickel(II) oxalate (NiC₂O₄), nickel(II) chloride (NiCl₂) and hydrates thereof, for example.

As the phosphate compound, there may be mentioned ammonium dihydrogen phosphate (NH₄H₂PO₄), phosphoric acid (H₃PO₄), lithium phosphate (Li₃PO₄), ammonium phosphate ((NH₄)₃PO₄) and hydrates thereof, for example.

It is preferable to determine the mixing ratio of the raw materials according to the compositional ratio of the elements in LiMPO₄. The ratio of the elements (except oxygen) in LiMPO₄ is Li:M:P=1:1:1. Therefore, the mixing ratio of the raw materials can be controlled so that the composition of the thus-obtained mixture corresponds to the elemental ratio.

Next, the mixture of the raw materials is dissolved in a predetermined acid to prepare a mixed solution. If the pH of the mixed solution is too high at this stage, impurities are likely to be produced. Therefore, for example, in the case of producing LiCoPO₄, the liquid property of the mixed solution is controlled by appropriately adding a concentrated nitric acid so that the mixed solution has a strongly acidic pH level of 1.5 or less.

Then, a chelant is added to the mixed solution to prepare a sol. This chelant functions to inhibit the growth of LiMPO₄ particles. The chelant is not particularly limited, as long as it is one that is generally used in sol-gel reaction. For example, there may be mentioned glycolic acid, citric acid, hydroxycarboxylic acid, gluconic acid, tartaric acid, glyceric acid, malic acid, isocitric acid and lactic acid.

The amount of the chelant is needed to be equal to or more than the molar amount of LiMPO₄, which is the target compound, and it can be 1 to 10 moles per mole of LiMPO₄.

Next, the sol is appropriately heated to remove water, thereby obtaining a gel precursor. The heating temperature is preferably 50 to 90° C., considering the balance between the boiling point of water contained in the sol and the solubility of the raw materials in water. The heating is needed to be terminated after the solvent is completely removed therefrom. The heating time is preferably 5 to 30 hours, for example.

It is preferable to completely remove water from the gel precursor, by heating the gel precursor further in a drying oven at 50 to 90° C. for approximately 5 to 30 hours.

By firing the dried gel precursor, LiMPO₄ is obtained. The heating method is not particularly limited, and it is preferable that the dried gel precursor is fired in an inert gas atmosphere such as argon atmosphere or nitrogen atmosphere. It is also preferable that firing is carried out in two stages of pre-fining and main firing.

The purpose of the pre-firing is to improve the dispersion state of the elements at the time of grinding and mixing that are carried out after the pre-firing, and to inhibit the production of impurities during the main firing. The temperature of the pre-firing is preferably 400 to 800° C.

A powdery product obtained after the pre-firing is ground with a mortar or the like and then subjected to the main-firing. The temperature of the main firing is preferably 500 to 900° C., more preferably 600 to 800° C. The main firing time is preferably 0.5 to 5 hours, more preferably 1 to 3 hours. When the main firing temperature is too high or the main firing time is too long, LiMPO₄ particles grow too much. As a result, the discharge capacity (initial capacity) of LiMPO₄ to be obtained may be low.

As the cathode active material, LiMPO₄ can be used alone, or LiMPO₄ can be used in combination with one or more kinds of other cathode active materials.

Concrete examples of other cathode active materials include LiCoO₂, LiNi_{1/3}Mn_{1/3}Co_{1/3}O₂, LiNiO₂, LiMn₂O₄, LiCoMnO₄, Li₂NiMn₃O₈, Li₃Fe₂(PO₄)₃ and Li₃V₂ (PO₄)₃. The surface of fine particles composed of the cathode active material can be covered with LiNbO₃, etc.

The total content of the cathode active material(s) in the cathode active material layer is generally within a range of 50 to 90% by mass.

The average particle diameter of the cathode active material used in the present invention is, for example, 1 to 50 μm, preferably 1 to 20 μm, particularly preferably 3 to 5 μm. When the average particle diameter of the cathode active material is too small, there is a possibility of poor handling properties. When the average particle diameter of the cathode active material is too large, there may be a difficulty in obtaining a flat cathode active material layer. The average particle diameter of the cathode active material can be obtained by, for example, measuring the particle diameters of the cathode active material, which are observed with a scanning electron microscope (SEM), and averaging the particle diameters.

The thickness of the cathode active material layer used in the present invention varies depending on the intended use, etc., of the target lithium battery. However, the thickness is preferably 10 to 250 μm, particularly preferably 20 to 200 μm, most preferably 30 to 150 μm.

As needed, the cathode active material layer can contain an electroconductive material, a binder, etc.

The electroconductive material used in the present invention is not particularly limited, as long as it can increase the electroconductivity of the cathode active material layer. The examples include carbon blacks such as acetylene black and Ketjen Black. The content of the electroconductive material in the cathode active material layer varies depending on the type of the electroconductive material; however, it is generally within a range of 1 to 30% by mass.

As the binder used in the present invention, for example, there may be mentioned polyvinylidene fluoride (PVdF) and polytetrafluoroethylene (PTFE). The content of the binder in the cathode active material layer is needed to be a content which can fix the cathode active material and so on and is preferably as small as possible. The content of the binder is generally within a range of 1 to 10% by mass.

To prepare the cathode active material, a dispersion medium such as N-methyl-2-pyrrolidone or acetone can be used.

The cathode current collector used in the present invention functions to collect current from the cathode active material layer. Examples of materials for the cathode current collector include aluminum, stainless-steel (SUS), nickel, iron and titanium, and preferred are aluminum and stainless-steel (SUS). Examples of the form of the cathode current collector include a foil form, a plate form and a mesh form. Preferred is a foil form.

The method for producing the cathode used in the present invention is not particularly limited, as long as it is a method by which the above-described cathode can be obtained. After forming the cathode active material layer, the layer can be pressed to increase the electrode density.

The density of the cathode is preferably 1.3 to 2.7 g/cc. When the density of the cathode is too low, electron conducting paths may not be sufficiently obtained. When the density of the cathode is too high, lithium ion conduction may become the rate determining step in battery reactions.

The anode used in the present invention preferably contains an anode active material layer containing a lithium titanate. In addition, it generally contains an anode current collector and an anode lead connected to the anode current collector.

The lithium titanate used in the present invention is not particularly limited, as long as (1) it contains a titanium element (Ti), a lithium element (Li) and an oxygen element (O) and (2) it has an oxidation-reduction potential which is lower than other cathode active materials such as lithium cobaltate and higher than carbon, lithium metals and so on (i.e., medium potential). By using such a lithium titanate as the anode active material, sodium metals are not precipitated on the surface of the anode, and the effect of the present invention, which is the effect of increasing initial capacity higher than conventional lithium batteries, is exerted.

As the lithium titanate, for example, there may be mentioned Li₄Ti₅O₁₂ and Li_{(4+x)/3}Ti_{(5+y)/3}O₄ (−1.5<x<1.5, −1.5<y<1.5).

As the anode active material, the lithium titanate can be used alone, or the lithium titanate can be used in combination with one or more kinds of other anode active materials.

The other anode active material(s) is not particularly limited, as long as it can store and/or release lithium ions. For example, there may be mentioned lithium metals, lithium alloys, metal sulfides containing a lithium element, metal nitrides containing a lithium element, and carbonaceous materials such as graphite. The anode active material can be in a powdery form or a thin film form.

Examples of lithium alloys include a lithium-aluminum alloy, a lithium-tin alloy, a lithium-lead alloy and a lithium-silicon alloy. Examples of metal nitrides containing a lithium element include a lithium-cobalt nitride, a lithium-iron nitride and a lithium-manganese nitride. As the anode active material, a lithium coated with a solid electrolyte can be also used.

The anode active material layer can be one containing the anode active material only, or it can be one containing the anode active material and at least one of an electroconductive material and a binder. For example, when the anode active material is in a foil form, it can be an anode active material layer containing the anode active material only. When the anode active material is in a powdery form, it can be an anode active material layer containing the anode active material and a binder. The electroconductive material and the binder will not be described here since they are the same as those contained in the cathode active material layer described above.

The thickness of the anode active material layer is not particularly limited. For example, it is within a range of 10 to 100 μm, preferably within a range of 10 to 50 μm.

Examples of materials for the anode current collector can be the same as those mentioned above as the examples of materials for the cathode current collector. The form of the anode current collector can be selected from the above-mentioned example forms of the cathode current collector.

The method for producing the anode used in the present invention is not particularly limited, as long as it is a method by which the anode can be obtained. After forming the anode active material layer, the layer can be pressed to increase the electrode density.

The liquid electrolyte used in the present invention is present between the cathode and the anode and functions to exchange lithium ions between the cathode and the anode. The liquid electrolyte contains a lithium salt and a sodium salt.

A major characteristic of the present invention is that the content of the sodium salt is more than 0 mol % and less than 30 mol % when the total content of the lithium salt and the sodium salt is taken as 100 mol %. As just described, by containing the sodium salt in the specific ratio, the desolvated state of lithium ions can be changed to a state which is different from the desolvated state shown in conventional liquid electrolytes containing no sodium salt. Since desolvation reaction needs high activation energy, it determines the rate of battery reaction. By the addition of the sodium salt, activation energy can be kept low in desolvation reaction. As a result, the battery reaction rate of a lithium battery can be increased, thus increasing the initial capacity.

When the content of the sodium salt is 30 mol % or more, the sodium ion concentration in the liquid electrolyte is too high. As a result, sodium ions account for the majority of lithium ion sites in the cathode active material (LiMPO₄). However, the ionic radium of sodium ions is larger than that of lithium ions. Therefore, the composition or crystal structure of the cathode active material breaks down, so that lithium ion insertion and extraction reactions are less likely to proceed.

When the total content of the lithium salt and the sodium salt is taken as 100 mol %, the content of the sodium salt is preferably 5 mol % or more, more preferably 10 mol % or more. Also, the content of the sodium salt is preferably 25 mol % or less, more preferably 20 mol % or less.

Examples of the lithium salt include inorganic lithium salts such as LiPF₆, LiBF₄, LiClO₄ and LiAsF₆, and organic lithium salts such as LiCF₃SO₃, LiN(SO₂CF₃)₂ (Li-TFSA), LiN(SO₂C₂F₅)₂ and LiC(SO₂CF₃)₃.

Examples of the sodium salt include inorganic sodium salts such as NaPF₆, NaBF₄, NaClO₄ and NaAsF₆, and organic sodium salts such as NaCF₃SO₃, NaN(SO₂CF₃)₂ (Na-TFSA), NaN(SO₂C₂F₅)₂ and NaC(SO₂CF₃)₃.

The total concentration of the lithium salt and the sodium salt in the liquid electrolyte is, for example, 0.5 to 3 mol/L, depending on the solvent used.

The potential deposited by sodium is 0.5 V(vs. Li/Li⁺), and lithium shows higher ionization tendency than sodium. Therefore, in conventional lithium batteries in which a lithium metal is used in the anode, lithium metal elution and sodium precipitation into the anode are likely to occur, when a liquid electrolyte containing a sodium salt is used. The sodium metal precipitated on the anode surface blocks lithium ion conduction between the anode and the liquid electrolyte. Therefore, the initial capacity of such a lithium battery still remains low.

In the present invention, however, the lithium titanate, which has a high oxidation-reduction potential, is used in the anode. As a result, there is no possibility of sodium metal precipitation on the surface of the anode, so that the battery of the present invention stably shows a high initial capacity.

As the liquid electrolyte, a non-aqueous liquid electrolyte or an aqueous liquid electrolyte can be used.

As the non-aqueous liquid electrolyte, generally, a non-aqueous liquid electrolyte containing the lithium salt, the sodium salt and a non-aqueous solvent is used. Examples of the non-aqueous solvent include ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethyl sulfoxide (DMSO) and mixtures thereof.

In the present invention, for example, an ionic liquid or the like can be used as the non-aqueous solvent. Examples of the ionic liquid include N-methyl-N-propylpiperidinium bis(trifluoromethanesulfonyl)amide (PP13TFSA), N-methyl-N-propylpyrrolidinium bis(trifluoromethanesulfonyl)amide (P13TFSA), N-butyl-N-methylpyrrolidinium bis(trifluoromethanesulfonyl)amide (P14TFSA), N,N-diethyl-N-methyl-N-(2-methoxyethyl)ammonium bis(trifluoromethanesulfonyl)amide (DEMETFSA) and N,N,N-trimethyl-N-propylammonium bis(trifluoromethanesulfonyl)amide (TMPATFSA).

As the aqueous liquid electrolyte, generally, an aqueous liquid electrolyte containing the lithium salt, the sodium salt and water is used. Examples of the lithium salt include lithium salts such as LiOH, LiCl, LiNO₃ and CH₃CO₂Li. Examples of the sodium salt include sodium salts such as NaOH, NaCl, NaNO₃ and CH₃CO₂Na.

In the lithium battery of the present invention, a separator can be present between the cathode and the anode, which is impregnated with the liquid electrolyte. Examples of the separator include porous films of polyethylene, polypropylene, etc., and non-woven fabrics such as a resin non-woven fabric and a glass fiber non-woven fabric.

In general, the lithium battery of the present invention contains a battery case for housing the cathode, the anode, the electrolyte layer, etc. Concrete examples of the form of the battery case include a coin form, a flat plate form, a cylindrical form and a laminate form.

### EXAMPLES

Hereinafter, the present invention will be described in more detail, by way of examples and comparative examples. The present invention is not limited to these examples.

### 1. Production of Lithium Battery

### Example 1

### 1-1. Synthesis of Cathode Active Material LiCoPO₄

Particles were synthesized by the sol-gel method. A lithium acetate dihydrate, a cobalt acetate tetrahydrate and an ammonium dihydrogenphosphate (they are raw materials all manufactured by Nacalai Tesque, Inc.) were weighed so that the elements are in a molar ratio of Li:Co:P=1:1:1. Then, the raw materials were dissolved in 1 L pure water, controlling the pH with concentrated nitric acid, so as to have a pH of 1.5 or less. Thereafter, glycolic acid, which is a chelant manufactured by Nacalai Tesque, Inc. and used to inhibit the growth of the particles, was dissolved in the solution. The amount of the glycolic acid dissolved in the solution was 5 moles per mole of LiCoPO₄ to be synthesized. With agitating the thus-obtained solution (sol) in an oil bath at 80° C., moisture was removed from the solution for about 20 hours, thus obtaining a gel precursor. The gel precursor was further dried in a drying oven at 80° C. for 24 hours. Then, the gel precursor was subjected to a pre-firing at a temperature of 600° C. The thus-obtained powdery product was ground with a mortar and then subjected to a main firing at a temperature of 600° C. for one hour in an argon atmosphere, thus synthesizing LiCoPO₄.

### 1-2. Production of Cathode

The above-obtained LiCoPO₄ was used as a cathode active material. Acetylene black was used as an electroconductive material. Polyvinylidene fluoride (PVdF) was used as a binder. The cathode active material, the electroconductive material and the binder were dispersed in an N-methyl-2-pyrrolidone (NMP) solution (manufactured by Nacalai Tesque, Inc.) at a ratio of cathode active material:electroconductive material:binder=85 mass %:10 mass %:5 mass %, thus obtaining a slurry. The slurry was applied onto a 15 μm aluminum foil (cathode current collector) by the doctor blade method, dried at a temperature of 80° C. for 30 minutes, pressed by a roll pressing machine so as to have an electrode density of 2 g/cc, and then vacuum-dried at a temperature of 120° C., thus obtaining the cathode.

### 1-3. Production of Anode

Li₄T₅O₁₂ was used as an anode active material. Acetylene black was used as an electroconductive material. Polyvinylidene fluoride (PVdF) was used as a binder. The anode active material, the electroconductive material and the binder were dispersed in a N-methyl-2-pyrrolidone (NMP) solution (manufactured by Nacalai Tesque, Inc.) at a ratio of anode active material:electroconductive material:binder=85 mass %:10 mass %:5 mass %, thus obtaining a slurry. Then, in the same manner as the production of the cathode, the slurry was applied onto a 15 μm aluminum foil (anode current collector), dried, pressed and then vacuum-dried, thus obtaining the anode.

### 1-4. Preparation of Liquid Electrolyte

A mixed solution of ethylene carbonate (EC) and diethyl carbonate (DEC) at a volume ratio of EC:DEC=3:7, was used as a solvent. In the solvent, LiPF₆, which is a lithium salt, was dissolved at a concentration of 0.9 mol/L, and NaPF₆, which is a sodium salt, was dissolved at a concentration of 0.1 mol/L, thus preparing a liquid electrolyte. The content of NaPF₆ in the liquid electrolyte is 10 mol %, when the total content of LiPF₆ and NaPF₆ is taken as 100 mol %.

### 1-5. Production of Lithium Battery

A coin cell (model: SUS2032) was used as a battery case. A polypropylene/polyethylene (PP/PE) multilayer porous film (manufactured by UBE Industries, Ltd.) was used as a separator. The cathode, the liquid electrolyte, the separator and the anode are housed in this order in the battery case, thereby obtaining the lithium battery of Example 1.

The above-mentioned processes were all carried out inside a glove box in a nitrogen atmosphere.

### Example 2

A liquid electrolyte was prepared by use of the same solvent as Example 1 and by dissolving LiPF₆, which is a lithium salt, at a concentration of 0.8 mol/L and NaPF₆, which is a sodium salt, at a concentration of 0.2 mol/L in the solvent. The content of NaPF₆ in the liquid electrolyte is 20 mol %, when the total content of LiPF₆ and NaPF₆ is taken as 100 mol %.

The lithium battery of Example 2 was produced in the same manner as Example 1, except the preparation of the liquid electrolyte.

### Comparative Example 1

A liquid electrolyte was prepared by use of the same solvent as Example 1 and by dissolving LiPF₆, which is a lithium salt, at a concentration of 1.0 mol/L in the solvent.

The lithium battery of Comparative Example 1 was produced in the same manner as Example 1, except the preparation of the liquid electrolyte.

### Comparative Example 2

A liquid electrolyte was prepared by use of the same solvent as Example 1 and by dissolving LiPF₆, which is a lithium salt, at a concentration of 0.7 mol/L and NaPF₆, which is a sodium salt, at a concentration of 0.3 mol/L in the solvent. The content of NaPF₆ in the liquid electrolyte is 30 mol %, when the total content of LiPF₆ and NaPF₆ is taken as 100 mol %.

The lithium battery of Comparative Example 2 was produced in the same manner as Example 1, except the preparation of the liquid electrolyte.

### Comparative Example 3

A liquid electrolyte was prepared by use of the same solvent as Example 1 and by dissolving LiPF₆, which is a lithium salt, at a concentration of 0.5 mol/L and NaPF₆, which is a sodium salt, at a concentration of 0.5 mol/L in the solvent. The content of NaPF₆ in the liquid electrolyte is 50 mol %, when the total content of LiPF₆ and NaPF₆ is taken as 100 mol %.

The lithium battery of Comparative Example 3 was produced in the same manner as Example 1, except the preparation of the liquid electrolyte.

### Comparative Example 4

Instead of producing an anode in the same manner as Example 1, an anode was prepared by attaching a lithium metal (anode active material layer) and a 15 μm aluminum foil (anode current collector) to each other.

A liquid electrolyte was prepared by use of the same solvent as Example 1 and by dissolving LiPF₆, which is a lithium salt, at a concentration of 1.0 mol/L in the solvent.

The lithium battery of Comparative Example 4 was produced in the same manner as Example 1, except the production of the anode and the preparation of the liquid electrolyte.

### Comparative Example 5

An anode was prepared in the same manner as Comparative Example 4. The lithium battery of Comparative Example 5 was produced in the same manner as Example 1, except the production of the anode.

### Comparative Example 6

An anode was prepared in the same manner as Comparative Example 4.

A liquid electrolyte was prepared by use of the same solvent as Example 1 and by dissolving LiPF₆, which is a lithium salt, at a concentration of 0.8 mol/L and NaPF₆, which is a sodium salt, at a concentration of 0.2 mol/L in the solvent. The content of NaPF₆ in the liquid electrolyte is 20 mol %, when the total content of LiPF₆ and NaPF₆ is taken as 100 mol %.

The lithium battery of Comparative Example 6 was produced in the same manner as Example 1, except the production of the anode and the preparation of the liquid electrolyte.

### Comparative Example 7

An anode was prepared in the same manner as Comparative Example 4.

A liquid electrolyte was prepared by use of the same solvent as Example 1 and by dissolving LiPF₆, which is a lithium salt, at a concentration of 0.7 mol/L and NaPF₆, which is a sodium salt, at a concentration of 0.3 mol/L in the solvent. The content of NaPF₆ in the liquid electrolyte is 30 mol %, when the total content of LiPF₆ and NaPF₆ is taken as 100 mol %.

The lithium battery of Comparative Example 7 was produced in the same manner as Example 1, except the production of the anode and the preparation of the liquid electrolyte.

### Comparative Example 8

An anode was prepared in the same manner as Comparative Example 4.

A liquid electrolyte was prepared by use of the same solvent as Example 1 and by dissolving LiPF₆, which is a lithium salt, at a concentration of 0.5 mol/L and NaPF₆, which is a sodium salt, at a concentration of 0.5 mol/L in the solvent. The content of NaPF₆ in the liquid electrolyte is 50 mol %, when the total content of LiPF₆ and NaPF₆ is taken as 100 mol %.

The lithium battery of Comparative Example 8 was produced in the same manner as Example 1, except the production of the anode and the preparation of the liquid electrolyte.

### 2. Charge-Discharge Test of Lithium Batteries

A charge-discharge test was conducted on the lithium batteries of Examples 1 and 2 and Comparative Examples 1 to 8. In particular, first, each battery was charged to an actual capacity of 150 mAh/g, in a constant current mode, under conditions of 0.1 C and the upper limit of 5 V. Then, the battery was discharged to 2.5 V to determine the discharge capacity (initial capacity).

FIG. 2 is a graph of the initial capacity (specific capacity) of the lithium batteries of Examples 1 and 2 and Comparative Examples 1 to 8, with respect to the content of NaPF₆ in the liquid electrolyte. FIG. 2 is also a graph with specific capacity (mAh/g) on the vertical axis and, on the horizontal axis, the content of NaPF₆ (mol %) in the liquid electrolyte when the total content of LiPF₆ and NaPF₆ is taken as 100 mol %.

First, among the examples shown in FIG. 2, experimental examples in which Li₄Ti₅O₁₂ was used as the anode active material (Examples 1 and 2 and Comparative Examples 1 to 3) will be discussed. From a comparison between Comparative Example 1 (NaPF₆: 0 mol %), Example 1(NaPF₆: 10 mol %) and Example 2 (NaPF₆: 20 mol %), it is clear that the initial capacity increases as the amount added of NaPF₆ increases, and that the initial capacity is the highest when the content of NaPF₆ is around 20 mol %. From a comparison between Example 2 (NaPF₆: 20 mol %), Comparative Example 2 (NaPF₆: 30 mol %) and Comparative Example 3 (NaPF₆: 50 mol %), it is clear that the initial capacity decreases as the amount added of NaPF₆ increases, and that the initial capacity of Comparative Example 3 is lower than that of Comparative Example 1. The reason is assumed to be that when the content of NaPF₆ is too high, the amounts of sodium ions inserted in and extracted from LiCoPO₄, which is the cathode active material, relatively increase; therefore, a phenomenon in which sodium ions are forced to be inserted in lithium ion sites occurs frequently, so that the composition of the cathode active material breaks down and results in the decrease in discharge capacity.

Next, among the examples shown in FIG. 2, experimental examples in which only the lithium salt was used in the liquid electrolyte (Comparative Examples 1 and 4) will be compared. As shown in FIG. 2, Comparative Examples 1 and 4 plotted on the graph are almost on top of each other, and it is clear that there is almost no difference between the initial capacities of the lithium batteries of Comparative Examples 1 and 4.

Next, among the examples shown in FIG. 2, experimental examples in which the lithium metal was used as the anode active material (Comparative Examples 4 to 8) will be discussed. From FIG. 2, it is clear that in Comparative Examples 4 to 8, the initial capacity decreases as the amount added of NaPF₆ increases. The reason is assumed to be that the standard electrode potential of Na (−2.714 V vs. SHE) is higher than that of Li (−3.054 V vs. SHE), so that sodium was precipitated on the anode, and battery reaction was inhibited by the precipitated sodium.

From the above, it is clear that in the case of using the liquid electrolyte containing both the lithium salt and the sodium salt, from the viewpoint of initial capacity, the content of the sodium salt is preferably more than 0 mol % and less than 30 mol %, when the total content of the lithium salt and the sodium salt is taken as 100 mol %. Also, over the entire range of FIG. 2, the initial capacities of the lithium batteries in which Li₄Ti₅O₁₂ was used as the anode active material (Examples 1 and 2 and Comparative Example 1 to 3) are equal to or higher than the initial capacities of the lithium batteries in which the lithium metal was used as the anode active material (Comparative Examples 4 to 8). Therefore, it is clear that in the case of using the liquid electrolyte containing both the lithium salt and the sodium salt, excellent effects are obtained when the liquid electrolyte is combined with the cathode containing LiCoPO₄ and the anode containing the lithium titanate.

The reason for the high initial capacity when the content of the sodium salt is in the above-specified range, is assumes as follows. There is a difference in the solvated state of cations between the case where two or more kinds of cations are present in the liquid electrolyte and the case where only one kind of cations are present in the liquid electrolyte. In Examples 1 and 2 in which, in addition to the lithium salt, the sodium salt is contained in an appropriate amount, extraction of lithium ions from the solvent is easier compared to Comparative Example 1 in which no sodium salt is contained; therefore, it is considered that lithium ion insertion reaction in the cathode active material is promoted. In the case of using the anode active material with a low potential, such as the lithium metal (Comparative Examples 3 to 8), sodium ions contained in the liquid electrolyte are reduced to sodium metal and precipitated on the anode surface, so that the initial capacity increasing effect is not obtained. Therefore, it is considered that the effects created by addition of the sodium salt to the liquid electrolyte, can be sufficiently achieved in the case where the anode active material with a relatively high potential.

### REFERENCE SIGNS LIST

1. Electrolyte layer
2. Cathode active material layer
3. Anode active material layer
4. Cathode current collector
5. Anode current collector
6. Cathode
7. Anode
100. Lithium battery

1. A lithium battery comprising:
a cathode containing LiMPO4 (in which M is at least one element selected from the group consisting of Co, Fe, Mn and Ni);
an anode containing a lithium titanate; and
a liquid electrolyte disposed between the cathode and the anode,
wherein the liquid electrolyte contains a lithium salt and sodium salt, and
wherein the content of the sodium salt is more than 0 mol % and less than 30 mol % when the total content of the lithium salt and the sodium salt is taken as 100 mol %.

2. The lithium battery according to claim 1, wherein the lithium salt is at least one lithium salt selected from the group consisting of LiPF6, LiBF4, LiClO4, LiAsF6, LiCF3SO3, LiN(SO2CF3)2, LiN(SO2C2F5)2 and LiC(SO2CF3)3.

3. The lithium battery according to claim 1, wherein the sodium salt is at least one sodium salt selected from the group consisting of NaPF6, NaBF4, NaClO4, NaAsF6, NaCF3SO3, NaN(SO2CF3)2, NaN(SO2C2F5)2 and NaC(SO2CF3)3.

4. The lithium battery according to claim 2, wherein the sodium salt is at least one sodium salt selected from the group consisting of NaPF6, NaBF4, NaClO4, NaAsF6, NaCF3SO3, NaN(SO2CF3)2, NaN(SO2C2F5)2 and NaC(SO2CF3)3.
